(19) United States
(12) Patent Application Publication
(10) Pub. No.: US 2024/0052803 A1
(43) Pub. Date: Feb. 15, 2024

(54) VERTICAL AXIS WIND TURBINES AND DEVICES THEREFOR

(71) Applicant: University of Cincinnati, Cincinnati, OH (US)

(72) Inventor: Shaaban Abdallah, Cincinnati, OH (US)

(73) Assignee: University of Cincinnati, Cincinnati, OH (US)

(21) Appl. No.: 18/268,861

(22) PCT Filed: Dec. 23, 2021
(86) PCT No.: PCT/US2021/065084

§ 371 Date: Jun. 21, 2023

Related U.S. Application Data
(60) Provisional application No. 63/129,764, filed on Dec. 23, 2020.
(60) Provisional application No. 63/129,774, filed on Dec. 23, 2020.

(51) Int. Cl. F03D 3/04

(52) U.S. Cl. CPC F03D 3/0427; F05B 2240/123; F05B 2240/211

(57) ABSTRACT

A vertical axis wind turbine including a nozzle is provided. The nozzle includes a first airfoil and a second airfoil. The first airfoil includes a first airfoil leading edge and a first airfoil trailing edge, and the second airfoil includes a second airfoil leading edge and a second airfoil trailing edge. The nozzle defines an inlet area disposed between the first airfoil leading edge and the second airfoil leading edge and an exit area disposed between the first airfoil trailing edge and the second airfoil trailing edge, wherein the exit area is smaller than the inlet area.

### CROSS REFERENCE TO RELATED APPLICATIONS

This application claims priority to U.S. Provisional Application Ser. No. 63/129,764, filed Dec. 23, 2020, and to U.S. Provisional Application Ser. No. 63/129,774, filed Dec. 23, 2020, the entire disclosures of which are incorporated herein by reference.

### TECHNICAL FIELD

The present specification generally relates to vertical axis wind turbines and to devices for use with vertical axis wind turbines.

### BACKGROUND

Vertical axis wind turbines may be used to harness wind energy with a number of blades or airfoils that rotate about a turbine axis. The blades of vertical axis wind turbines span in a direction generally parallel to the turbine axis. This differs from the blades of horizontal wind turbines, which span in a direction generally perpendicular to the turbine axis. Many vertical axis wind turbines are not self-starting. Instead, they require an additional device or power input to initiate rotation of the blades about the turbine axis. Accordingly, a vertical axis wind turbine configured to be self-starting may be beneficial.

### SUMMARY

Additional features and advantages of the present disclosure will be set forth in the detailed description, which follows, and in part will be apparent to those skilled in the art from that description or recognized by practicing the embodiments described herein, including the detailed description, which follows the claims, as well as the appended drawings.

In a first aspect A1, a vertical axis wind turbine includes a nozzle. The nozzle includes a first airfoil and a second airfoil. The first airfoil includes a first airfoil leading edge and a first airfoil trailing edge, and the second airfoil includes a second airfoil leading edge and a second airfoil trailing edge. The nozzle defines an inlet area disposed between the first airfoil leading edge and the second airfoil leading edge and an exit area disposed between the first airfoil trailing edge and the second airfoil trailing edge, wherein the exit area is smaller than the inlet area.

In a second aspect A2 according to the first aspect A1, the first airfoil has a substantially symmetric airfoil shape. In a third aspect A3 according to the first aspect A1, the first airfoil has a non-zero chamber. In a fourth aspect according to the first aspect A1 or the third aspect A3, the first airfoil defines a first airfoil chord line, and the first airfoil has an inner surface substantially aligned with the first airfoil chord line. In a fifth aspect A5 according to any preceding aspect A1-A4, the second airfoil is shaped substantially the same as the first airfoil. In a sixth aspect A6 according to any preceding aspect A1-A5, the nozzle is configured to be operatively coupled to a rotational shaft of the vertical axis wind turbine. In a seventh aspect A7 according to any of the first through fifth aspects A1-A5, the nozzle is configured to be rotationally independent of a rotational shaft of the vertical axis wind turbine. In an eighth aspect A8 according to any preceding aspect A1-A7, the inlet area is configured to be oriented in a radial direction relative to a rotational axis of the vertical axis wind turbine. In a ninth aspect A9 according to any preceding aspect A1-A8, the nozzle is operable to rotate a rotational shaft.

In a tenth aspect A10, a vertical axis wind turbine includes a rotational shaft and a first nozzle operatively coupled to the rotational shaft. The first nozzle includes a first airfoil and a second airfoil. The first airfoil includes a first airfoil leading edge and a first airfoil trailing edge, and the second airfoil includes a second airfoil leading edge and a second airfoil trailing edge. The first nozzle defines an inlet area disposed between the first airfoil leading edge and the second airfoil leading edge and an exit area disposed between the first airfoil trailing edge and the second airfoil trailing edge, wherein the exit area is smaller than the inlet area.

In an eleventh aspect A11 according to the tenth aspect A10, the first airfoil and the second airfoil are substantially symmetric relative to each other. In a twelfth aspect A12 according to the tenth aspect A10 or the eleventh aspect A11, the vertical axis wind turbine further includes a second nozzle operatively coupled to the rotational shaft and a third nozzle operatively coupled to the rotational shaft. In a thirteenth aspect A13 according to the twelfth aspect A12, the first nozzle, the second nozzle, and the third nozzle are equally spaced about the rotational shaft. In a fourteenth aspect A14 according to the twelfth aspect A12 or the thirteenth aspect A13, the first nozzle, the second nozzle, and the third nozzle generate a combined resulting force when the vertical axis wind turbine is subjected to wind, wherein the combined resulting force is greater than a threshold force required to rotate the rotational shaft.

In a fifteenth aspect A15, a vertical axis wind turbine includes a rotational shaft, a rotating airfoil operatively coupled to the rotational shaft, and a nozzle disposed radially outward of the rotating airfoil. The nozzle includes a first airfoil and a second airfoil. The first airfoil includes a first airfoil leading edge and a first airfoil trailing edge, and the second airfoil includes a second airfoil leading edge and a second airfoil trailing edge. The nozzle defines an inlet area disposed between the first airfoil leading edge and the second airfoil leading edge and an exit area disposed between the first airfoil trailing edge and the second airfoil trailing edge, wherein the exit area is smaller than the inlet area.

In a sixteenth aspect A16 according to the fifteenth aspect A15, the nozzle is operable to rotate the rotational shaft. In a seventeenth aspect A17 according to the fifteenth aspect A15 or the sixteenth aspect A16, the vertical axis wind turbine further includes a second nozzle. In an eighteenth aspect A18 according to any of the fifteenth through seventeenth aspects A15-A17, the first airfoil has a non-zero chamber. In a nineteenth aspect A19 according to any of the fifteenth though eighteenth aspects A15-A18, the vertical axis wind turbine further includes a ring disposed about the rotational shaft, wherein the nozzle is fixedly coupled to the ring. In a twentieth aspect A20 according to the nineteenth aspect A19, the ring is rotatable relative to the rotational shaft.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description, explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a vertical axis wind turbine, according to one or more embodiments shown and described herein;

FIG. 2 schematically depicts a top view of the vertical axis wind turbine of FIG. 1, according to one or more embodiments shown and described herein;

FIG. 3 schematically depicts a top view of a nozzle, according to one or more embodiments shown and described herein;

FIG. 4 schematically depicts a perspective view of a vertical axis wind turbine, according to one or more embodiments shown and described herein;

FIG. 5 schematically depicts a perspective view of a vertical axis wind turbine, according to one or more embodiments shown and described herein;

FIG. 6 schematically depicts a perspective view of a vertical axis wind turbine, according to one or more embodiments shown and described herein; and

FIG. 7 schematically depicts a top view of a vertical axis wind turbine, according to one or more embodiments shown and described herein.

### DETAILED DESCRIPTION

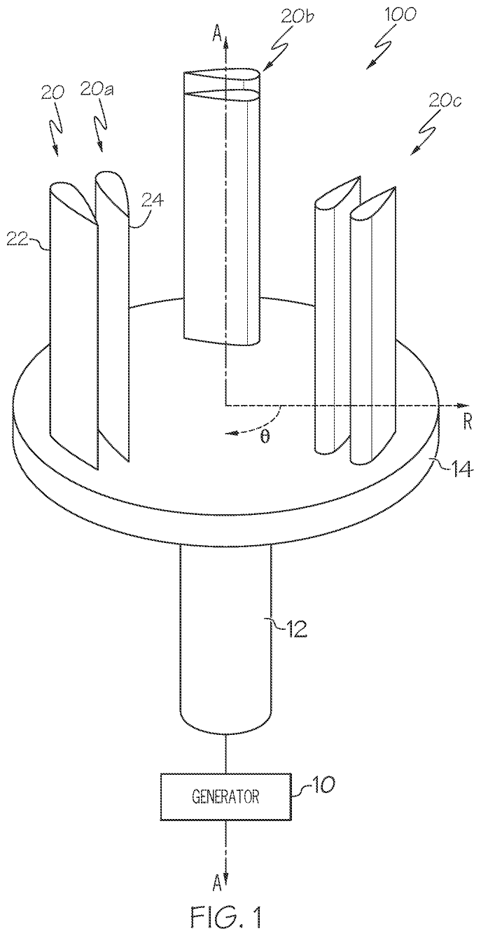

Reference will now be made in detail to various embodiments of devices, assemblies, and methods, examples of which are illustrated in the accompanying drawings. Whenever possible, the same reference numerals will be used throughout the drawings to refer to the same or like parts. FIG. 1 schematically depicts a vertical axis wind turbine with at least one nozzle. The nozzle includes a first airfoil and a second airfoil. The first airfoil includes a first airfoil leading edge and a first airfoil trailing edge, and the second airfoil includes a second airfoil leading edge and a second airfoil trailing edge. The nozzle defines an inlet area disposed between the first airfoil leading edge and the second airfoil leading edge and an exit area disposed between the first airfoil trailing edge and the second airfoil trailing edge, wherein the exit area is smaller than the inlet area. Accordingly, wind may accelerate through the nozzle due to the decreased cross sectional area. This acceleration of the wind may impart a resulting force on the nozzle, which may be operable to self-start the vertical axis wind turbine. Accordingly, vertical axis wind turbines according to the present disclosure may self-start without need for an auxiliary power device.

Directional terms as used herein—for example up, down, right, left, front, back, top, bottom—are made only with reference to the figures as drawn and are not intended to imply absolute orientation unless otherwise specified.

While vertical axis wind turbines are generally mounted such that the wind turbine axis and blade span directions are oriented vertically, vertical axis wind turbines may also be mounted in various other orientations relative to a ground surface, such as horizontal. Accordingly, the term “vertical” as used herein in connection with vertical axis wind turbines and related components is not limiting to a traditional vertical orientation of such components.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any device or assembly claim does not actually recite an order or orientation to individual components, or it is not otherwise specifically stated in the claims or description that the steps are to be limited to a specific order, or that a specific order or orientation to components of an device or assembly is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation; and the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Referring to FIG. 1, an embodiment of a vertical axis wind turbine 100 is schematically shown. The vertical axis wind turbine 100 generally includes a rotational shaft 12 extending along a rotational axis A and rotatable about the rotational axis A in a rotation direction θ. The rotational axis A may define a radial direction R perpendicular to the rotational axis A. The rotational shaft 12 may be coupled to a generator 10 for converting rotational mechanical energy of the vertical axis wind turbine 100 into electrical energy.

The vertical axis wind turbine 100 may include at least one nozzle 20, such as nozzles 20a, 20b, and 20c. In embodiments, the nozzles 20a, 20b, and 20c may be equally spaced about the rotational shaft 12, such as depicted. It is noted that while the vertical axis wind turbine 100 is depicted with three nozzles 20a, 20b, and 20c, a greater or fewer number of nozzles is contemplated and possible. The at least one nozzle 20 may be positioned at a radial distance (e.g. in the radial direction R) relative to the rotational shaft 12. That is, the at least one nozzle 20, may be radially offset from the rotational axis A. It is noted that each of the at least one nozzles may be radially offset from the rotational axis A the same or different distances. As will be described in greater detail herein, the at least one nozzle 20 may be operatively coupled to the rotational shaft 12, for example, via a support structure 14.

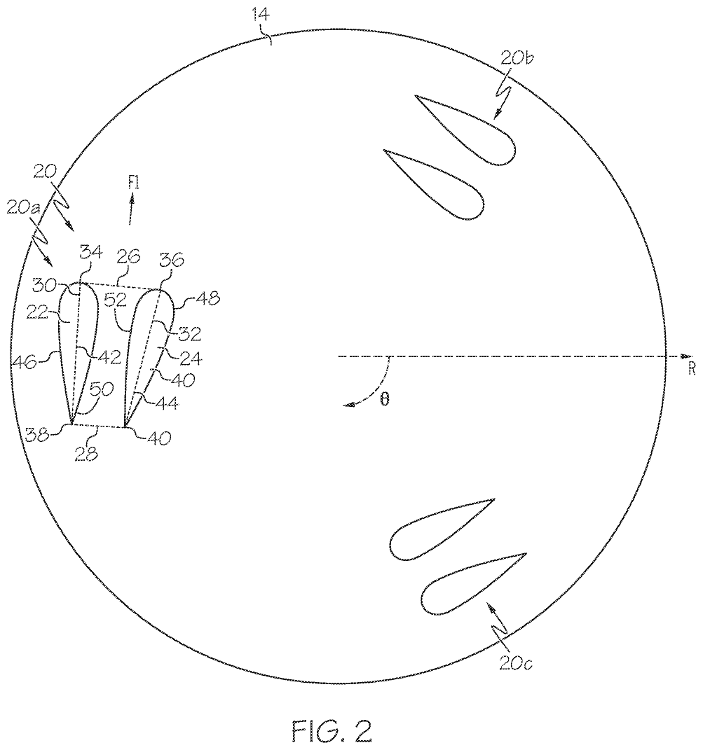

Referring to FIG. 2, the at least one nozzle 20, for examples, nozzle 20a, may include a first airfoil 22 and a second airfoil 24. The first airfoil 22 may have a leading edge 34 and a trailing edge 38, opposite the leading edge 34. The first airfoil 22 may have an outer surface 46, extending from the leading edge 34 to the trailing edge 38, and an inner surface 50, also extending from the leading edge 34 to the trailing edge 38, that is radially inward of the outer surface 46 relative to the rotational axis A. As depicted, the first airfoil 22 may have a variable thickness between the trailing edge 38 and the leading edge 34. For example, the first airfoil may be narrower at the trailing edge 38 than at the leading edge 34. In other embodiments, the first airfoil 22 may have a constant thickness from the leading edge 34 to the trailing edge 38.

The first airfoil 22 may define a chord line 30 that extends in a straight line between the leading edge 34 and the trailing edge 38. The first airfoil also defines a mean chamber line 42 that extends through the center of the first airfoil 22 from the leading edge 34 to the trailing edge 38. In other words, the mean chamber line 42 may be equally spaced from the outer surface 46 and the inner surface 50. The chamber of the airfoil is defined as the distance between the chord line 30 and the mean chamber line 42. In some embodiments, and as depicted in FIG. 2, the first airfoil 22 may have a substantially symmetrical airfoil shapes with a chamber approximately equal to zero. Accordingly, the chord line 30 and the mean chamber line 42 may be substantially aligned. As will be described in greater detail herein, in other embodiments, the first airfoil 22 may have a chord line 30 and a mean chamber line 42 that are wholly or partially spaced apart.

In embodiments, the second airfoil 24 may be similarly shaped to the first airfoil 22. Accordingly, the second airfoil 24 may have a leading edge 36, a trailing edge 40, an outer surface 52, and an inner surface 48, such as described in relation to the first airfoil 22, above. The second airfoil 24 may define a chord line 32 and a mean chamber line 44, such as described in relation to the first airfoil 22, above. It is noted that, while the first airfoil 22 and the second airfoil 24 may have substantially the same shape in some embodiments, such as depicted in FIG. 2, in other embodiments, the shape of the second airfoil 24 may differ from the shape of the first airfoil 22.

Still referring to FIG. 2, the at least one nozzle 20 may define a inlet area 26 extending between the leading edge 34 of the first airfoil 22 and the leading edge 36 of the second airfoil 24. The at least one nozzle 20 may also define an exit area 28 extending between the trailing edge 38 of the first airfoil 22 and the trailing edge 40 of the second airfoil 24. In some embodiments, the first airfoil 22 and the second airfoil 24 may be oriented such that the inlet area 26 is substantially normal to the rotation direction θ. In some embodiments, the first airfoil 22 and the second airfoil 24 may be oriented such that the exit area 28 is substantially normal to the rotation direction θ. In some embodiments, the first airfoil 22 and the second airfoil 24 may be oriented such that neither the inlet area 26 nor the exit area 28 are substantially normal to the rotation direction θ.

As depicted, in some embodiments, the exit area 28 may be smaller than the inlet area 26. Accordingly, as wind flows from the inlet area 26 to the exit area 28 between the first airfoil 22 and the second airfoil 24, the wind will accelerate due to the decreased cross sectional area. This acceleration of the wind may impart a resulting force F1 on the at least one nozzle 20 in the rotation direction θ or partially in the rotation direction θ. In some embodiments, the resulting force F1 may be sufficient to overcome a threshold force required to rotate the at least one nozzle 20, thereby rotating the rotational shaft 12. Accordingly, in some embodiments, the at least one nozzle 20 may direct wind streams sufficiently to cause rotation of the rotational shaft 12 without need for any additional mechanical or electrical starter (e.g., engine, rotational actuator, etc.).

Referring back to FIG. 1, it is noted that, while the first airfoil 22 and the second airfoil 24 are depicted as being stacked along a straight vertical line (e.g. parallel to the rotational axis A), in other embodiments the first airfoil 22 or the second airfoil 24 or both may be stacked differently. For example, in embodiments, the first airfoil 22 may be stacked such that the first airfoil 22 is curved, for example, in a C-Shape. In embodiments, the first airfoil 22 may be stacked such that the first airfoil 22 extends in a helical shape about the rotational axis A.

As stated, in some embodiments, the at least one nozzle 20 may include, for example, three nozzles 20a, 20b, and 20c. In such an embodiment, the acceleration of the wind through each of the three nozzles, 20a, 20b, and 20c, may generate a combined resulting force on the vertical axis wind turbine 100. In some such embodiments, the combined resulting force may be greater than a threshold force required to rotate the rotational shaft.

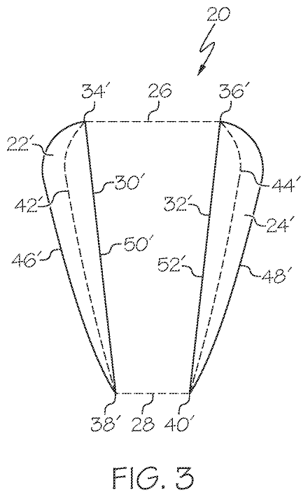

Referring now to FIG. 3, an alternative embodiment of a first airfoil 22′ and a second airfoil 24′ to the first and second airfoils 22, 24 described above, are schematically depicted. The first airfoil 22′ may have a leading edge 34′ and a trailing edge 38′, opposite the leading edge 34′. The first airfoil 22′ may have an outer surface 46′, extending from the leading edge 34′ to the trailing edge 38′, and an inner surface 50′, also extending from the leading edge 34′ to the trailing edge 38′. The second airfoil 24′ may have a leading edge 36′ and a trailing edge 40′, opposite the leading edge 36′. The second airfoil 24′ may have an outer surface 52′, extending from the leading edge 36′ to the trailing edge 40′, and an inner surface 48′, also extending from the leading edge 36′ to the trailing edge 40′.

In some embodiments, the first airfoil 22′ may have a non-zero chamber. Accordingly, the first airfoil 22′ may define a mean chamber line 42′ that is offset from the chord line 30′. As depicted, the first airfoil 22′ may be shaped such that the chord line 30′ is substantially aligned with the inner surface 50′. In a similar manner, the second airfoil 24′ may also have a non-zero chamber. Accordingly, the second airfoil 24′ may define a mean chamber line 44′ that is offset from the chord line 32′. The second airfoil 24′ may be shaped such that the chord line 32′ is substantially aligned with the outer surface 52′. As depicted, the first airfoil 22′ and the second airfoil 24′ may be substantially symmetric relative to each other about a center line between the first airfoil 22′ and the second airfoil 24′. However, other geometries are contemplated and possible.

Referring back to FIG. 1, the at least one nozzle 20 may be operatively coupled to the rotational shaft 12. In some embodiments, the at least one nozzle 20 may be operatively coupled with a support structure 14. The at least one nozzle 20 may be bolted, screwed, integrally formed or otherwise attached to the support structure 14. Accordingly, the rotational shaft 12 may be rotated upon a rotation of the at least one nozzle 20. The support structure 14 may extend from the rotational shaft 12 to the at least one nozzle 20. The support structure 14 may be a plate or a substrate, such as depicted. In other embodiments, the support structure 14 may be a plurality of shafts or rods connecting the at least one nozzle 20 to the rotational shaft 12. As depicted, the support structure 14 may have a substantially circular cross section in a horizontal direction (e.g. perpendicular to the vertical axis A). However, other shapes are contemplated and possible. For example, the support structure 14 may be rectangular, ovular, triangular, or any regular or non-regular polygonal or non-polygonal shape. In some embodiments, and as depicted in FIG. 1, the support structure 14 may be a lower support structure coupled to the bottom of the at least one nozzle 20.

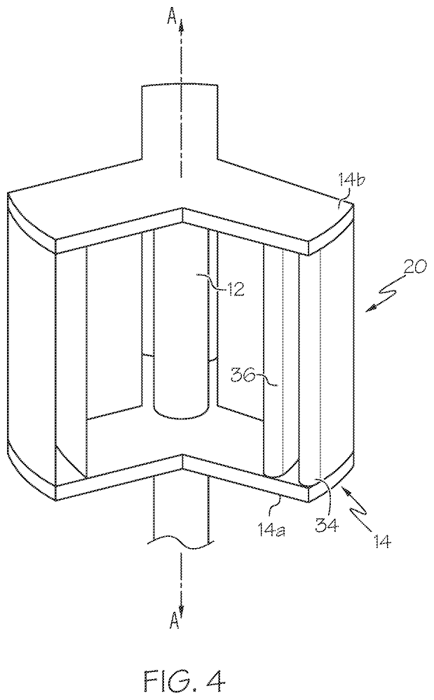

Referring to FIG. 4, in some embodiments, the support structure 14 may include both a lower support structure 14a and an upper support structure 14b. Each of the lower support structure 14a and the upper support structure 14b may extend from the rotational shaft 12 to the at least one nozzle 20. The lower support structure 14a may be coupled to the bottom of the at least one nozzle 20, while the upper support structure 14b may be coupled to the top of the at least one nozzle 20. Each of the lower support structure 14a and upper support structure 14b may be a polygonal plate, such as depicted. However, other shapes are contemplated and possible. For example, in other embodiments, one or both of the lower support structure 14a and upper support structure 14b may be a plurality of shafts or rods. In other embodiments, one or both of the lower support structure 14a and upper support structure 14b may be circular, rectangular, ovular, triangular, or any regular or non-regular polygonal or non-polygonal shape.

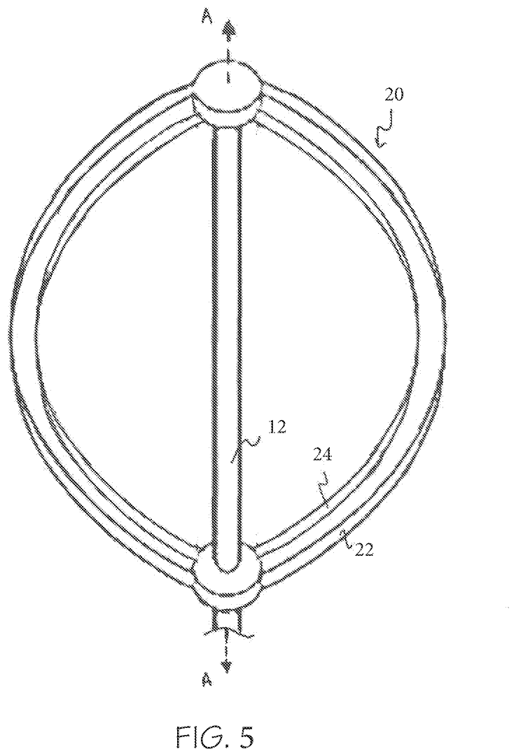

Referring to FIG. 5, in other embodiments, the at least one nozzle 20 may be directly coupled to the rotational shaft 12 such as without a support structure. For example, if the at least one nozzle 20 includes a curved or C-shaped nozzle, the at least one nozzle 20 may be coupled at its top and bottom to the rotational shaft 12. In such embodiments, the at least one nozzle 20 may be bolted, screwed, integrally formed or otherwise attached to the rotational shaft 12. Accordingly, the rotational shaft 12 may be rotated upon a rotation of the at least one nozzle 20.

Each component of the vertical axis wind turbine, for example, the at least one nozzle 20 or the rotational shaft 12, may be made from a metallic material, such as aluminum or metal alloy, or non-metallic material, such as wood or composite material.

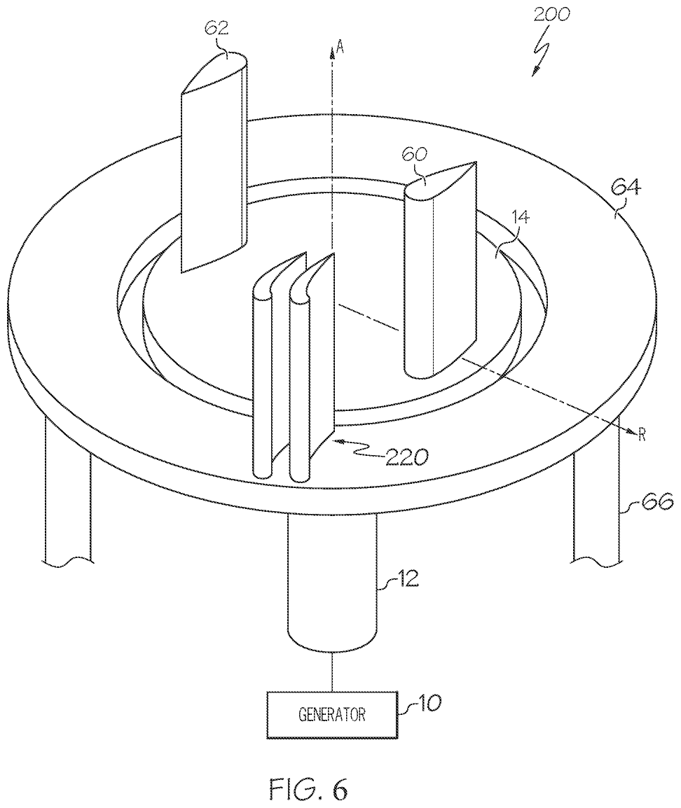

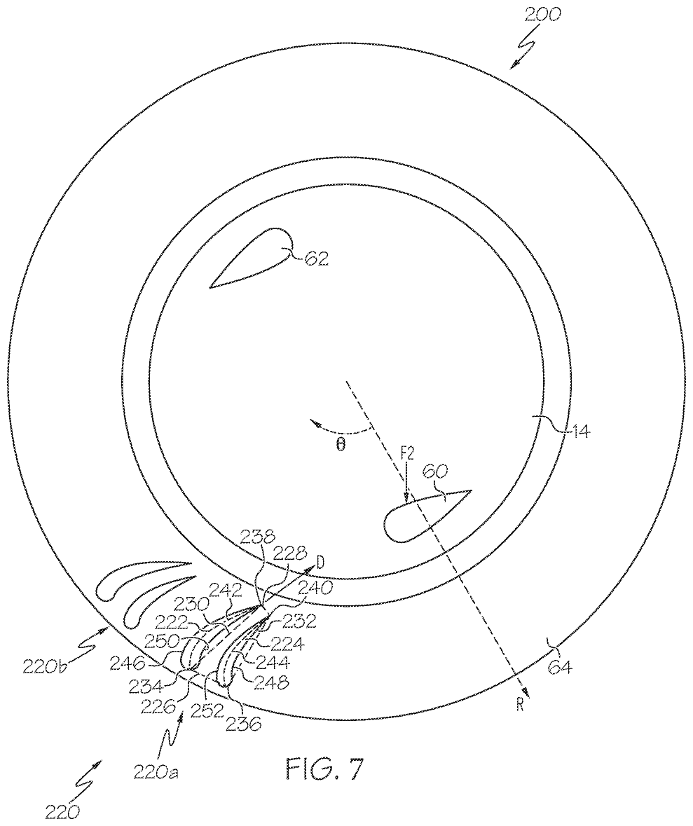

Referring to FIG. 6, an embodiment of a vertical axis wind turbine 200 is schematically shown. The vertical axis wind turbine 200 may include a first rotating airfoil 60 operatively coupled to the rotational shaft 12 with the support structure 14. The first rotating airfoil 60 may have an airfoil shape such that it generates a lift when acted upon by wind and may accordingly rotate in the rotation direction θ (depicted in FIG. 7). In embodiments, the vertical axis wind turbine 200 may include one or more additional rotating airfoils, such as a second rotating airfoil 62. The second rotating airfoil 62 may also be operatively coupled to the rotational shaft 12 via the support structure 14.

Disposed radially outward of the first rotating airfoil 60 (e.g. in the radial direction R), the vertical axis wind turbine 200 may include at least one nozzle 220. It is noted that, while the vertical axis wind turbine 200 is depicted in FIG. 6 as having a single nozzle, a greater number of nozzles is contemplated and possible. For example, as depicted in FIG. 7, the at least one nozzle 220 may include a first nozzle 220a and a second nozzle 220b.

Referring to FIG. 7, the at least one nozzle 220, may include a first airfoil 222 and a second airfoil 224. The first airfoil 222 may have a leading edge 234 and a trailing edge 238, opposite the leading edge 234. The first airfoil 222 may have a first surface 246 and a second surface 250, each extending from the leading edge 234 to the trailing edge 238. As depicted, the first airfoil 222 may have a variable thickness between the trailing edge 238 and the leading edge 234. For example, the first airfoil 222 be narrower at the trailing edge 238 than at the leading edge 234. In other embodiments, the first airfoil 222 may have a constant thickness from the leading edge 234 to the trailing edge 238.

The first airfoil 222 defines a chord line 230 that extends in a straight line between the leading edge 234 and the trailing edge 238. The first airfoil 222 also defines a mean chamber line 242 that extends through the center of the first airfoil 222 from the leading edge 234 to the trailing edge 238. In other words, the mean chamber line 242 will be equally spaced between the first surface 246 and the second surface 250. In some embodiments, and as depicted in FIG. 7, the first airfoil 222 may have a non-zero chamber such that the chord line 230 and the mean chamber line 242 that are spaced apart.

In embodiments, the second airfoil 224 may be similarly shaped to the first airfoil 222. Accordingly, the second airfoil 224 may have a leading edge 236, a trailing edge 240, a first surface 252, and a second surface 248, such as described in relation to the first airfoil 222, above. The second airfoil 224 may define a chord line 232 and a mean chamber line 244, such as described in relation to the first airfoil 222, above. It is noted that, while the first airfoil 222 and the second airfoil 224 may have substantially the same shape in some embodiments, such as depicted in FIG. 7, in other embodiments, the shape of the second airfoil 224 may differ from the shape of the first airfoil 222.

Still referring to FIG. 7, the at least one nozzle 220 may define a inlet area 226 extending between the leading edge 234 of the first airfoil 222 and the leading edge 236 of the second airfoil 224. The at least one nozzle 220 may also define an exit area 228 extending between the trailing edge 238 of the first airfoil 222 and the trailing edge 240 of the second airfoil 224. The exit area 228 may define an exit direction D that is substantially perpendicular to the exit area 228. Accordingly, as wind flows between the first airfoil 222 and the second airfoil 224 of the at least one nozzle 220, the wind will be redirected to align with the exit direction D. In embodiments, the exit direction D may be oriented such that the wind, moving in the exit direction D, may cause a resulting force F2 acting on the first rotating airfoil 60 of the vertical axis wind turbine 200. In some embodiments, this resulting force F2 may be directed or partially directed in the rotation direction θ. In some embodiments, the resulting force F2 may be sufficient to start rotation of the vertical axis wind turbine 200 from a stationary or stopped state. Accordingly, in some embodiments, the at least one nozzle 220 may be operable to rotate the rotational shaft 12, and the vertical axis wind turbine 200 may therefore be self-starting.

As depicted in FIG. 7, in some embodiments, the exit area 228 may be smaller than the inlet area 226. Accordingly, as wind flows from the inlet area 226 to the exit area 228 between the first airfoil 222 and the second airfoil 224, the wind may accelerate due to the decreased cross sectional area. This may increase the momentum of the wind as it is directed in the exit direction D. Accordingly, the wind may exert an increased resulting force F2 on the first rotating airfoil 60 of the vertical axis wind turbine 200.

It is noted that, while the at least one nozzle 220 is depicted as having a first airfoil 222 and a second airfoil 224, in some embodiments, the at least one nozzle 220 may have one or more additional airfoils, such as a third airfoil, spaced from the second airfoil 224 such that the at least one nozzle 220 defines a second inlet area and a second exit area between the second airfoil 224 and the third airfoil.

Referring still to FIG. 7, in some embodiments, the at least one nozzle 220 may include a first nozzle 220a and a second nozzle 220b. As depicted, the second nozzle 220b may have a substantially similar geometry to the first nozzle 220a. However, other geometries are contemplated and possible. The second nozzle 220b may be spaced apart from the first nozzle 220a. In some embodiments, the at least one nozzle 220 may include one or more additional nozzles, such as a third nozzle (not depicted).

Referring back to FIG. 6, the at least one nozzle 220 may be coupled to a nozzle support structure 64. For example, the at least one nozzle 220 may be bolted, screwed, integrally formed or otherwise attached to the nozzle support structure 64. In some embodiments, the at least one nozzle 220 may be rotably fixed to the nozzle support structure 64. That is, the at least one nozzle 220 may be configured to rotate across a surface of the support structure 64. For example, in some such embodiments, the at least one nozzle 220 may include a linkage arm (not depicted) to form a crank-linkage type rotational mechanism. In other embodiments, the at least one nozzle 220 may be fixed on a rotational base coupled to an actuator (not depicted), such as, for example, those commonly used in variable stator vane designs.

As depicted, the nozzle support structure 64 may be a ring. The nozzle support structure 64 may be positioned radially outward of the first rotating airfoil 60 and the support structure 14 (e.g. in the radial direction R). In some embodiments, the nozzle support structure 64 may encircle the support structure 14 of the vertical axis wind turbine 200. As depicted, the nozzle support structure 64 may be a lower support structure coupled to the bottom of the at least one nozzle 220. However, in other embodiments, the nozzle support structure 64 may include, alternatively or additionally, an upper support structure coupled to the top of the at least one nozzle. 220. In embodiments the nozzle support structure 64 may align the at least one nozzle at substantially the same vertical location (e.g. along the rotational axis A) as the first rotating airfoil 60.

The nozzle support structure 64 may be rotationally independent of the first rotating airfoil 60 and the support structure 14. For example, in some embodiments, the nozzle support structure 64 may be stationary while the support structure 14 rotates. In some embodiments, the nozzle support structure 64 may be rotatable such that it may rotate at a different speed or in a different direction relative to the support structure 14. The nozzle support structure 64 may be rotated using mechanical or electrical means. For example, in some embodiments, the nozzle support structure 64 may be manually rotated. In other embodiments, the nozzle support structure 64 may be connected to a power source (not depicted) operable to rotate the nozzle support structure 64. Accordingly, the nozzle support structure 64 may be rotatable such that the at least one nozzle 220 may be positioned at a desired orientation relative to the first rotating airfoil 60.

Still referring to FIG. 6, the nozzle support structure 64 may be elevated by one or more elevating members 66. The one or more elevating members 66 may be shafts, columns, trusses, or other support structures. The one or more elevating members 66 may be any size or shape appropriate to elevate and support the nozzle support structure 64. In some embodiments, the one or more elevating members 66 may suspend the at least one nozzle 220 from above. In embodiments, the one or more elevating members 66 may elevate the nozzle support structure 64 to substantially align with the support structure 14. The nozzle support structure 64 may be rotatably coupled to the one or more elevating members 66 such that the nozzle support structure 64 may rotate on the one or more elevating members 66.

In light of FIGS. 6 and 7, a method of starting the vertical axis wind turbine 200 may therefore include rotating the nozzle support structure 64 to position the at least one nozzle 220 at a desired orientation relative to the first rotating airfoil 60. For example a desired orientation may include positioning the at least one nozzle 220 at an orientation relative to the first rotating airfoil 60 to direct wind to the first rotating airfoil 60, such that a resultant force F2 acts on the first rotating airfoil 60. That is, once positioned, the at least one nozzle 220 may direct wind passing through the at least one nozzle 220 such that it exits the at least one nozzle 220 in the exit direction D. The wind, moving in the exit direction D, may cause the resulting force F2 acting on the first rotating airfoil 60, thereby rotating the first rotating airfoil 60.

Still referring to FIG. 6, in some embodiments, the at least one nozzle 220 may be rotatable to a position relative to the at least one nozzle 220 such that the at least one nozzle 220 causes the wind directed through the at least one nozzle 220 at the exit direction D to exert a stopping force or otherwise fail to exert a lifting force, such as the resulting force F2, on the first rotating airfoil 60. For example, the at least one nozzle 220 may be rotated to redirect the exit direction D such that it forms a stall configuration with the first rotating airfoil 60. In some embodiments, the stopping force acting on the first rotating airfoil 60 may be directed or partially directed opposite the rotation direction θ. In other words, in some embodiments, the stopping force may oppose the rotation of the first rotating airfoil 60. Accordingly, in at least some embodiments, the at least one nozzle 220, when rotating with the nozzle support structure 64, may be operable to stop the rotation of the first rotating airfoil 60. A method of stopping the vertical axis wind turbine 200 may therefore include rotating the nozzle support structure 64.

In view of the above, it should now be understood that at least some embodiments of the present disclosure are directed to a nozzle for a vertical axis wind turbine. The nozzle includes a first airfoil and a second airfoil. The first airfoil includes a first airfoil leading edge and a first airfoil trailing edge, and the second airfoil includes a second airfoil leading edge and a second airfoil trailing edge. The nozzle defines an inlet area disposed between the first airfoil leading edge and the second airfoil leading edge and an exit area disposed between the first airfoil trailing edge and the second airfoil trailing edge, wherein the exit area is smaller than the inlet area.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A vertical axis wind turbine comprising a nozzle, the nozzle comprising:
a first airfoil comprising a first airfoil leading edge and a first airfoil trailing edge; and
a second airfoil comprising a second airfoil leading edge and a second airfoil trailing edge;
wherein the nozzle defines:
an inlet area disposed between the first airfoil leading edge and the second airfoil leading edge; and
an exit area disposed between the first airfoil trailing edge and the second airfoil trailing edge, wherein the exit area is smaller than the inlet area, and wherein the inlet area is oriented normal to a rotational direction of the vertical axis wind turbine.

2. The vertical axis wind turbine of claim 1, wherein the first airfoil has a substantially symmetric airfoil shape.

3. The vertical axis wind turbine of claim 1, wherein the first airfoil has a non-zero chamber.

4. The vertical axis wind turbine of claim 1, wherein:
the first airfoil defines a first airfoil chord line; and
the first airfoil has an inner surface substantially aligned with the first airfoil chord line.

5. The vertical axis wind turbine of claim 1, wherein the second airfoil is shaped substantially the same as the first airfoil.

6. The vertical axis wind turbine of claim 1, wherein the nozzle is configured to be operatively coupled to a rotational shaft of the vertical axis wind turbine.

7. The vertical axis wind turbine of claim 1, wherein the nozzle is configured to be rotationally fixed to a rotational shaft of the vertical axis wind turbine such that the rotational shaft is rotated upon rotation of the nozzle.

8. (canceled)

9. The vertical axis wind turbine of claim 1, wherein the nozzle is operable to rotate a rotational shaft.

10. A vertical axis wind turbine comprising:
a rotational shaft; and
a first nozzle operatively coupled to the rotational shaft, the first nozzle comprising:
a first airfoil comprising a first airfoil leading edge and a first airfoil trailing edge; and
a second airfoil comprising a second airfoil leading edge and a second airfoil trailing edge, wherein the first nozzle defines:
an inlet area disposed between the first airfoil leading edge and the second airfoil leading edge; and
an exit area disposed between the first airfoil trailing edge and the second airfoil trailing edge, wherein the exit area is smaller than the inlet area, and wherein the inlet area is oriented normal to a rotational direction of the vertical axis wind turbine.

11. The vertical axis wind turbine of claim 10, wherein the first airfoil and the second airfoil are substantially symmetric relative to each other.

12. The vertical axis wind turbine of claim 10, further comprising a second nozzle operatively coupled to the rotational shaft and a third nozzle operatively coupled to the rotational shaft.

13. The vertical axis wind turbine of claim 12, wherein the first nozzle, the second nozzle, and the third nozzle are equally spaced about the rotational shaft.

14. The vertical axis wind turbine of claim 12, wherein the first nozzle, the second nozzle, and the third nozzle generate a combined resulting force when the vertical axis wind turbine is subjected to wind, wherein the combined resulting force is greater than a threshold force required to rotate the rotational shaft.

15. A vertical axis wind turbine comprising:
a rotational shaft;
a rotating airfoil operatively coupled to the rotational shaft; and
a ring disposed radially outward of the rotating airfoil, wherein the ring is rotatable relative to the rotational shaft such that the ring may be rotated at a different speed than the rotational shaft; and
a nozzle fixedly coupled to the ring, the nozzle comprising:
a first airfoil comprising a first airfoil leading edge and a first airfoil trailing edge; and
a second airfoil comprising a second airfoil leading edge and a second airfoil trailing edge, wherein the nozzle defines:
an inlet area disposed between the first airfoil leading edge and the second airfoil leading edge; and
an exit area disposed between the first airfoil trailing edge and the second airfoil trailing edge, wherein the exit area is smaller than the inlet area.

16. The vertical axis wind turbine of claim 15, wherein the nozzle is operable to rotate the rotational shaft.

17. The vertical axis wind turbine of claim 15 further comprising a second nozzle.

18. The vertical axis wind turbine of claim 15, wherein the first airfoil has a non-zero chamber.

19. (canceled)

20. The vertical axis wind turbine of claim 10, wherein the ring is rotatable when the rotational shaft is stationary.
